(19) United States
(12) Patent Application Publication
(10) Pub. No.: US 2017/0185493 A1
(43) Pub. Date: Jun. 29, 2017

(54) DATABASE TRANSACTION REPLAY

(71) Applicant: Hewlett Packard Enterprise Development LP, Houston, TX (US)

(72) Inventor: Goetz GRAEFE, Madison, WI (US)

(21) Appl. No.: 15/320,636

(22) PCT Filed: Jul. 15, 2014
(86) PCT No.: PCT/US2014/046728

§ 371 Date: Dec. 20, 2016

(51) Int. Cl. G06F 11/14; G06F 17/30

(52) U.S. Cl. CPC G06F 11/1474; G06F 11/1471; G06F 17/30943; G06F 11/1402

(57) ABSTRACT

Systems and methods associated with database transaction replay are described. In one example, a computer-readable medium may store computer-executable instructions. When executed by a computer, the instructions may cause the computer to prevent a database page from being written to a persistent portion of a database. The database page may be prevented from being written while there are uncommitted transactions associated with the database page. The instructions may also cause the computer to detect a system failure associated with the database. In response to the system failure, the instructions may cause the computer to analyze the database to identify a set of transactions that were committed and unwritten to the persistent portion when the system failure occurs. The instructions may cause the computer to then re-perform members of the set of transactions.

### BACKGROUND

Database atomicity is the principle that transactions either fully commit, and all changes associated with the transaction are preserved in the database, or the transaction fails and no changes associated with the transaction are preserved. When a system failure in a database occurs, many recent changes to the database may be lost. These changes are typically changes that have been stored in, for example, a buffer pool while the changes are waiting to be written to the database. Even though some of the changes may have been committed, many databases implement a “no-force” policy which allows pages with committed changes to remain unpreserved in the buffer pool (e.g., “dirty”) instead of “forcing” the page to be written to the database's storage media after each commit. Consequently, the “no-force” policy may reduce the number of page writes, thereby improving database efficiency, but in the event of a system failure, committed changes must be recovered.

After a system failure (e.g., a crash), databases may attempt to recover information lost due to the failure. To preserve database atomicity for unwritten but committed transactions a redo phase and an undo phase are performed by the database after the failure. The redo phase re-performs on the database actions performed since a previous checkpoint of the database, and the undo phase reverts changes that are found to be associated with uncommitted transactions. Once the undo phase completes, the database may be treated as being again ready for normal transaction processing, which may include re-attempting transactions that failed due to the system failure.

To perform the redo phase and the undo phase, during normal transaction processing, write ahead logging may be employed to ensure that changes made to the database are re-performed in the event of a system failure. Write ahead logging is a technique that ensures that changes to the database are written to a log before the changes are made in the database itself. These changes include “redo” information and “undo” information. Redo information may relate to changes that have been committed but not yet stored to a storage media. In the event of a system failure, committed but un-stored changes may need to be replayed. Undo information may relate to changes that were stored on a persistent storage media but were associated with uncommitted transactions when the store occurred. In the event the transaction does not commit (e.g., due to a system failing, due to a problem with the transaction), these changes may need to be reverted in persistent storage to preserve database atomicity. Some actions redone may also be undone if it is determined that a completed action is associated with an uncommitted transaction.

### BRIEF DESCRIPTION OF THE DRAWINGS

The present application may be more fully appreciated in connection with the following detailed description taken in conjunction with the accompanying drawings.

FIG. 1 illustrates example system associated with replaying database transactions.

FIG. 2 illustrates a flowchart of example operations associated with replaying database transactions.

FIG. 3 illustrates another flowchart of example operations associated with replaying database transactions.

FIG. 4 illustrates another flowchart of example operations associated with replaying database transactions.

FIG. 5 illustrates an example system associated with replaying database transactions.

FIG. 6 illustrates another flowchart of example operations associated with replaying database transactions.

FIG. 7 illustrates an example computing environment in which example systems and methods, and equivalents, may operate.

### DETAILED DESCRIPTION

Systems and methods associated with replaying database transactions are described. Specifically, systems and methods described illustrate how to avoid logging undo information in recovery logs. Recovery logs without undo information may be substantially shorter than recovery logs with undo information. Furthermore, as storing information to recovery logs takes processor and/or memory storage resources, eliminating information from the recovery log may reduce the amount of these resources consumed by logging undo information. Systems and methods described also illustrate how to omit performing an undo phase during recovery after a system failure. Avoiding the undo phase during system recovery may reduce the amount of time the database is unavailable after a system failure.

As used herein, undo information generally refers to undo information stored in a persistent recovery log and a recovery log generally refers to a persistent recovery log. Though techniques described herein generally describe omission of undo information from recovery logs, active transactions may temporarily have undo information stored (e.g., in an in memory data structure) in the event the transaction needs to be rolled back while the database is live. As is described below, undo information is kept out of persistent recovery logs because uncommitted pages do not reach a persistent portion of a database to avoid the need to revert changes associated with the uncommitted pages in the event of a system failure.

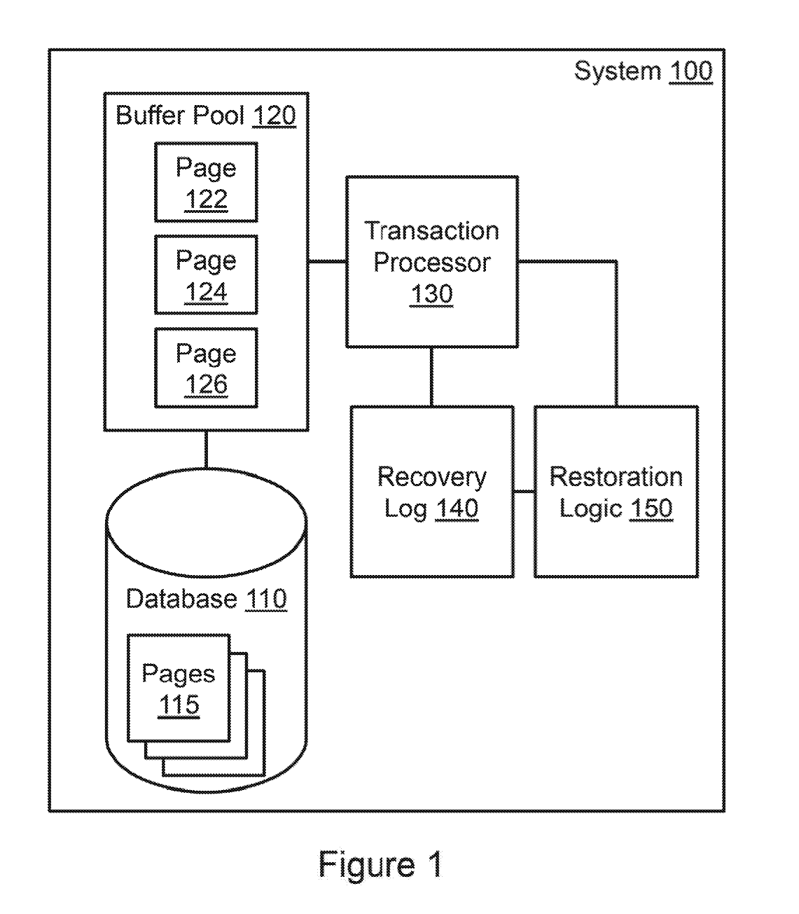

FIG. 1 illustrates an example system 100 associated with replaying database transactions. System 100 includes a database 110. Database 110 may reside on a storage media such as a hard disk. Database 110 may be made up of numerous database pages 115.

System 100 also includes a transaction processor 130. Transaction processor may run transactions on pages 115 from database 110. These transactions may, for example, create, delete, resize, modify, obtain information from, and so forth, pages 115 from the database 110. Transaction processor 130 may operate within a computer's processor, and so forth.

System 100 also includes a buffer pool 120. Buffer pool 120 may store database pages (e.g., page 122, page 124, page 126) while they are being modified by transactions being performed by transaction processor 130. Buffer pool 120 may be implemented, for example, in a cache between database 110 and transaction processor 130. Buffer pool 120 may be used because accessing pages from database 110 is slow due different access speeds of various aspects of a memory hierarchy of system 100. Thus, buffer pool 120 may be used to manage which database pages are kept in a memory type that is quickly accessible by transaction processor 130 as compared to other memory types. Transaction processor 130 may implement a “no-force” policy, meaning pages may not be committed from buffer pool 120 to database 110 when transactions associated with the page are committed. This may be desirable when a page is regularly changed, to prevent a large number of loads and stores of the page, which may degrade system performance.

Because undo information is stored when pages with uncommitted changes are stored to a persistent portion of database 110, transaction processor 130 may avoid storing this information by avoiding storing these uncommitted changes to the persistent portion of database 110. This may be achieved using a variety of techniques.

One example technique may include preserving pages associated with uncommitted transactions in buffer pool 120. This may be appropriate for transactions that manipulate a relatively small number of pages or during periods of time where there is a relatively low amount of contention for buffer pool resources.

If a system failure occurs while changes associated with a committed transaction remains in the buffer pool, the changes may be reconstructed by redoing actions associated with the transaction during system recovery. Changes associated with uncommitted transactions may be lost, but because the uncommitted transactions did not commit, these changes would be discarded to preserve database atomicity. Because the changes were not committed to a persistent portion of the database by preserving the changes associated with the uncommitted transaction in the buffer pool, the changes may not need to be undone because the changes never reached the persistent portion of the database and were lost due to the system failure.

Another example technique may include writing pages associated with uncommitted transactions to a portion of database 110 that is separate from the persistent portion of database 110. By way of illustration, if database 110 is implemented as a partitioned B-Tree, one or more partitions of the tree may be dedicated to storing pages associated with uncommitted transactions. When the transactions commit, these pages may be copied or otherwise associated with the persistent portion of database 110.

In one example, it may be desirable to create new pages in a non-persistent partition, while holding linking pages in the buffer pool. Linking pages refer to pages that would link the new pages to the persistent partition if the linking pages are stored in the persistent partition. The pages being held separate may then be merged into the persistent portion by writing the linking pages to appropriate locations in the persistent portion of the data store. By way of illustration, consider a database having a persistent portion organized using a tree structure where pages represent nodes. New pages may be held separate from the persistent portion by writing them to unallocated space in the database, and then the pages that link to these new pages may be written into the database (e.g., to overwrite an old page that does not link to the new pages occupying previously unallocated space) when transactions associated with these new pages are committed. Thus, in this example, the linking pages may be newer versions of intermediary nodes within the tree.

In this example, if a system failure occurs, though pages containing changes associated with the uncommitted transaction may have been stored in the database, these changes are still separate from the persistent portion of the database. Specifically, though memory may have been allocated in the database for these changes, information marking these allocations may be lost due to the system failure, causing the system to “forget” it allocated these resources, and causing the memory to be treated as un-allocated going forward. As before, when restoring the database to its state prior to the system failure, transactions that committed but did not reach the database due to a no-force commit policy may be re-performed after analyzing a log (e.g., recovery log 140) which should remain accurate due to write-ahead logging.

Transaction processor 130 may also be responsible for separating out actions that cause a database entry structure change. A database entry structure change may be caused by, for example, an action that creates or deletes an entry, modifies a size of an entry, and so forth. By way of illustration, if a database entry stores a text document that is increased in size by a user transaction, more space may need to be allocated for the entry so the text document does not end up overwriting other entries. Thus, transaction processor 130 may prevent user transactions from performing actions that modify a structure of database entries, and when one of these types of actions is necessary, a system transaction may be created to perform the structure modification.

Different types of modification actions may cause structure modifications to be appropriate at different times relative to the corresponding user action that would trigger the modification. For example, a triggering transaction that has an action that would cause an entry to be reduced in size may be separated in a way so the size reduction is not performed until the triggering action has been committed. Delaying the shrinking of the physical space allocated the entry may prevent another entry filling space no longer being used, by, for example, being created or expanded. This may prevent errors from occurring if the triggering transaction ends up being rolled back and the original space has been filled by the other entry. Consequently, the modification actions may effectively create ghost space and/or ghost pages in the database that will be cleaned up later as corresponding transactions commit, during designated database cleanup periods (e.g., during periods of low database usage), and so forth.

System 100 also includes a recovery log 140. When transactions complete actions on pages in the buffer pool, these actions may be recorded in recovery log 140. Recovery log 140 may be useful for ensuring that changes to database 110 since a recent backup are recorded in the event of certain types of database failures. For example, in the event of a media failure resulting in, for example, the loss of a portion of database 110, recovery log 140 may facilitate restoring database 110 to a state prior to the media failure in combination with one or more backups. In another example, recovery log 140 may be used in the event of a system failure causing a loss of volatile memory (e.g., buffer pool 120, transaction processor 130) to recover recent changes to the database that were not yet stored to database 110. Transaction processor 130 may perform write-ahead logging to ensure that changes made to pages (e.g., pages in buffer pool 120) are logged to recovery log 140 prior to the changes being made to the pages.

System 100 also includes a restoration logic 150. In the event of a system failure causing, for example, system 100 to lose the state of one or more of transaction processor 130 and buffer pool 120, restoration logic 150 may be responsible for recovering the state of the database prior to the system failure. Restoration logic 150 may read through recovery log 140 to identify transactions that committed but had entries stored in pages that were not yet written to database 110 prior to the system failure. Restoration logic 150 may then replay these transactions to preserve database atomicity. Because database 110 does not hold pages having uncommitted changes that are associated with a persistent portion of database 110, restoration logic 150 may not need to perform an undo phase that reverts uncommitted changes.

It is appreciated that, in the following description, numerous specific details are set forth to provide a thorough understanding of the examples. However, it is appreciated that the examples may be practiced without limitation to these specific details. In other instances, methods and structures may not be described in detail to avoid unnecessarily obscuring the description of the examples. Also, the examples may be used in combination with each other.

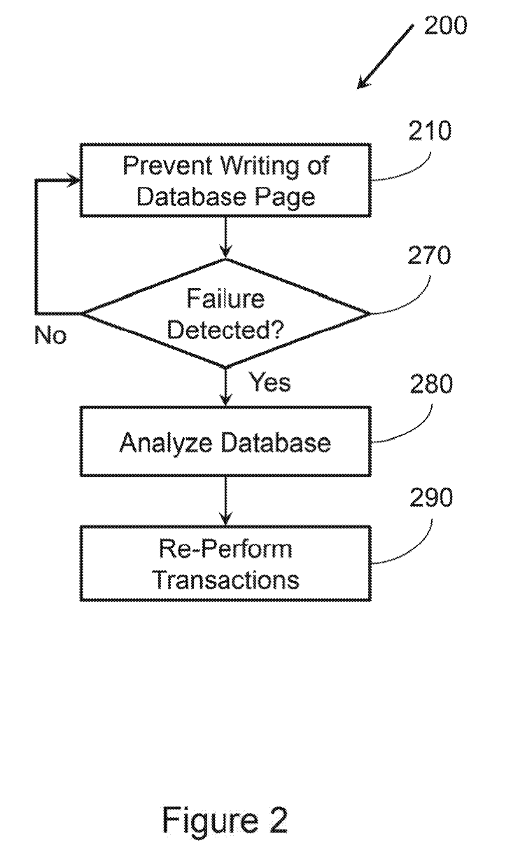

FIG. 2 illustrates a method 200 associated with database transaction replay. Method 200 may be embodied on a computer-readable medium, storing computer-executable instructions. The instructions, when executed by the computer may cause the computer to perform method 200. Method 200 includes preventing a database page from being written to a persistent portion of a database at 210. The database page may be prevented from being written to the persistent portion while there are uncommitted transactions associated with the database page.

Depending on what technique is used to hold the database page separate from the persistent portion of the database, different techniques may be used to merge the database page into the persistent portion of the database page. For example, the database page may be prevented from being written to the persistent portion by holding the database page in a buffer pool. In this case, once transactions associated with the database page have committed, it may be safe to simply write the database page to the persistent portion of the database.

In other cases, some transactions may be so large that the number of pages modified over the course of the transaction does not fit in the buffer pool. In these cases the database page may be prevented from being written to the persistent portion of the database by storing the database page in a portion of the database separate from the persistent portion of the database. By way of illustration, the database may be structured as a partitioned b-tree, and the portion of the database separate from the persistent portion of the database may be a dedicated partition of the partitioned b-tree.

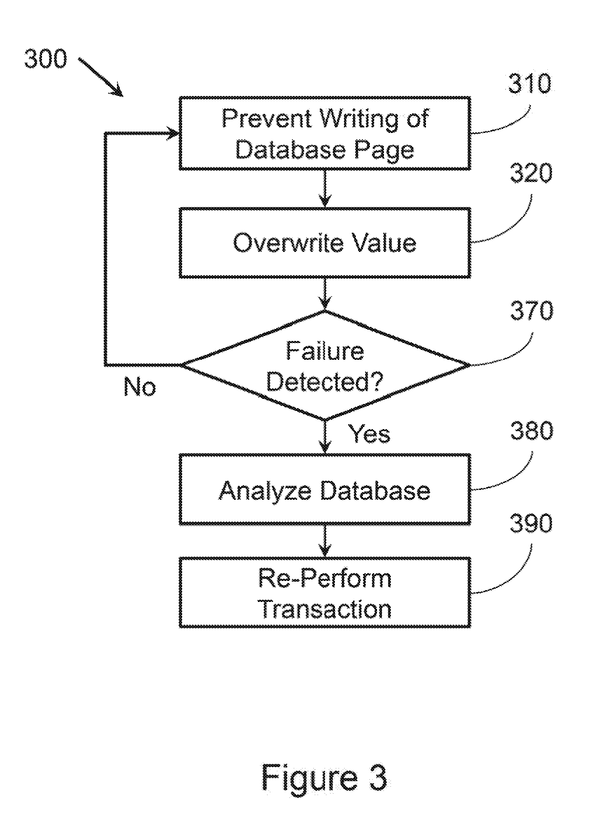

Thus, space in the database ay be allocated for the database page despite the database page being associated with uncommitted transactions. Ensuring the database page remains separate may involve delaying updating an associated page (e.g., a parent page, a page listing active pages in the database) to reflect the fact that the memory for the database page has been allocated until transactions associated with the database page have committed. In this scenario, method 300 (described below with reference to FIG. 3) may be used when writing the database page to the persistent portion of the database page.

The method also includes detecting a system failure associated with the database at 270. If no failure is detected at 270, the database may continue to operate in a transaction processing mode and consequently method 200 may return to action 210. If a failure is detected at 270, the database may enter a system restoration mode to attempt to restore the database to a state the database had prior to the system failure. In this case, method 200 may proceed to action 280 and analyze the database. The database may be analyzed to identify a set of transactions that were committed and unwritten to the persistent portion of the database when the system failure occurred. Transactions committed and written to the persistent portion do not need to be replayed. Uncommitted transactions do not need to be replayed to preserve database atomicity, and do not need to be undone because uncommitted transactions did not reach the persistent portion of the database.

Analyzing the database to identify the set of transactions may include analyzing a recovery log associated with the database. The recovery log may list actions performed on pages in the database and when transactions causing the actions to be performed commit. Analyzing the database may also include appending a compensation log record to the recovery log. The compensation log record may identify an action associated with an uncommitted transaction. The compensation log may signify that the action should not be reflected in the database which may speed up recovery of the database in the event of a subsequent system failure.

Once the set of transactions has been identified, method 200 includes re-performing members of the set of transactions at 290. Re-performing members of the set of transactions may restore the database to a state the database had prior to the system failure. Identifying the committed but unwritten transactions to replay may ensure that only actions that do not need to be undone are performed at 290. Committed and written transactions do not need to be redone because the database already reflects changes associated with committed and written transactions. Actions associated with uncommitted transactions do not need to be redone or undone because the changes have been kept separate from the persistent portion of the database and were effectively discarded by the system failure. Upon restoration of the system, some systems may attempt to perform, from their respective beginnings, transactions that were active at the time of the system failure.

FIG. 3 illustrates a method 300 associated with database transaction replay. Method 300 includes several actions similar to those described above with reference to method 200 (FIG. 2). For example, method 300 includes preventing a database page from being written to a persistent portion of a database at 310, detecting a failure at 370, analyzing the database at 380, and re-performing the transaction at 390. Method 300 also includes overwriting a value at 320. Overwriting the value in the database may indicate that the database page should be treated as part of the persistent portion of the database. The value may be overwritten once the uncommitted transactions have been committed.

As mentioned above, overwriting the value may require different actions depending on how the database page is kept separate from the persistent portion of the database. If the database page is held in the buffer pool, overwriting the value may include overwriting an old version of the database page in the database with the version of the database page held in the buffer pool. For larger transactions, overwriting the value may include overwriting a page so that the database page is now properly linked to the database (e.g., as above in the example above describing the b-tree). In another example, the database page may contain a flag bit that marks whether or not the page should be treated as part of the persistent portion of the database. Consequently, overwriting the value may include changing the flag bit to reflect that the page should be treated as a part of the persistent portion of the database.

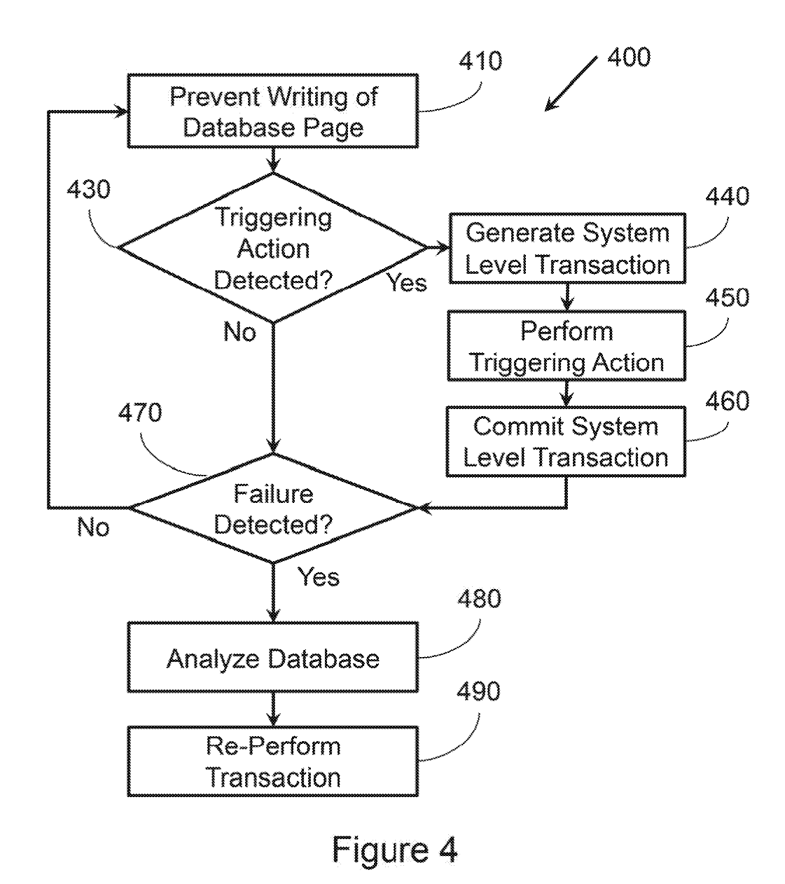

FIG. 4 illustrates a method 400 associated with database transaction replay. Method 400 includes several actions similar to those described above with reference to method 200 (FIG. 2). For example, method 400 includes preventing a database page from being written to a persistent portion of a database at 410, detecting a failure at 470, analyzing the database at 480, and re-performing the transaction at 490. Method 400 also includes detecting a triggering action at 430. The triggering action may be associated with a user transaction. Additionally, the triggering action may cause a modification of a structure of a database entry. Thus the triggering action may be an action that would cause, for example, creation of the database entry, deletion of the database entry, resizing or the database entry, and so forth. When such a triggering action is not detected, method 400 may proceed to determining whether a failure of the database has occurred at 470.

When such a triggering action is detected, method 400 may generate a system level transaction 440. The system level transaction may perform the modification of the structure of the database entry. For example, if the triggering action would trigger creation of a new entry having specified contents, a system level transaction may be generated to perform the allocation actions associated with creating the new database entry (e.g., allocating space in an in use page, formatting a new page and allocating space in the new page). Once the system level transaction commits, the user level transaction having the triggering action may modify the new space to have the specified contents. Ultimately the database may look the same as if the user level transaction had been allowed to perform the triggering actions itself. However, in the event the user level transaction has to be rolled back, separating the database entry structure modification actions may prevent certain types of errors that could be caused by user actions modifying database entry structures.

One example of this is a case where a page contains two database entries. If a first transaction shrinks the first entry but does not commit, and a second transaction expands the second entry and then commits, if the first transaction needs to roll back, there may not be space in the page, or in a worse case, anywhere in the database, which could cause a failure. By relegating the resizing actions to system transactions, the resizing of the first entry by a system transaction may be delayed until the first transaction commits. Until this occurs, there may simply be empty, or “ghost space”, that is unused until the system transaction is performed to release the memory. When the second transaction attempts to expand the second entry, the second transaction will have to identify a different page in which to store the expanded entry if the expanded second entry does not fit in the page the un-shrunk first entry. Though this may fall, the failure of the second transaction is preferable to any issues caused by the failure of the first transaction to roll back (e.g., a system failure, a stall).

Method 400 also includes performing the triggering action on the database entry 450 and committing the system level transaction at 460. It should be appreciated that depending on various factors, actions 440, 450, and 460 may be performed in different orders and at different times. The various factors may include, for example, the type of modification of the structure of the database entry, when the computer performing method 400 is configured to attempt to reclaim previously in use memory that has since been freed, and so forth. In one example, performing the modification of the structure of the database may create a ghost database entry or ghost space within a database entry. In this example, instructions may also cause the computer to reclaim memory associated with the use of the ghost database entry (not shown) or the ghost space within the database entry.

A ghost database entry may be, for example, an entry that is allocated but marked in a way that keeps it separate from persistent database entries. The ghost database entry therefore may contain temporary and/or to be committed changes to the database while preserving space for those changes until the changes are ready to be committed to the database. Ghost space may allow an entry to reserve space for itself while the contents of the entry are being modified by other transactions. Eventually, memory allocated for ghost database entry and for ghost space may need to be reclaimed so the memory becomes available for other database entries. This reclamation process may be performed as transactions associated with ghost entries commit, during periods of low usage of the database, and so forth. Reclamation actions may depend on the type of transaction that created the ghost database entry or the ghost space. For example, ghost pages no longer in use may be marked as available, pages with ghost space may be condensed so that entries appear consecutively and free space appears at the end of entries within the pages, and so forth.

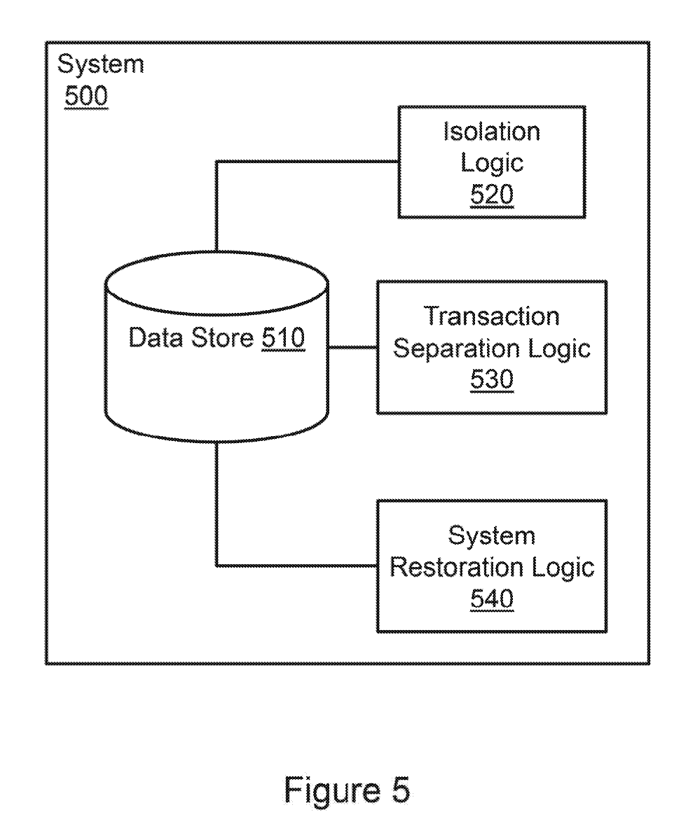

FIG. 5 illustrates an example system 500 associated with database transaction replay. System 500 includes a data store 510 to store a set of pages of data associated with a database. Data store 510 may be, for example, a memory device on which database data is stored, and consequently system 500 may be a database server that processes transactions associated with a database.

System 500 also includes an isolation logic 520. Isolation logic 520 may hold a database page separate from a persistent portion of data store 510 while transactions associated with the database page remain uncommitted. For other reasons, the database page may be held separate from data store 510 even though there may be no uncommitted transactions associated with the database page. For example, if the database page is frequently involved in numerous small transactions, it may be inefficient to repeatedly write the database page to data store 510. In one example, the isolation logic may hold the database page separate from persistent portion of the database by preserving the database page in a buffer pool, a portion of the database separate from the persistent portion of the database, and so forth.

System 500 also includes a transaction separation logic 530. Transaction separation logic 530 may detect when a triggering action of a user level transaction would cause a modification to a structure of a member of the set of database pages in data store 510. Transaction logic 530 may also generate a system level transaction to separate the modification of the structure and the triggering action. The system level transaction may modify the structure of the member of the set of pages by generating a ghost page to be held separate from the database at least until the user level transaction commits.

System 500 also includes a system restoration logic 540. System restoration logic 540 may selectively cause a transaction to be re-performed during a restoration of the database. The transaction may be re-performed when restoration logic 540 determines the transaction was committed prior to beginning the restoration of the database. In one example, system restoration logic 540 may scan a recovery log to identify transactions that committed prior to beginning restoration of the database. The system restoration logic may also append a compensation log record to the recovery log that identifies an action associated with an uncommitted transaction. The compensation log record may signify that the action should not be reflected in the database.

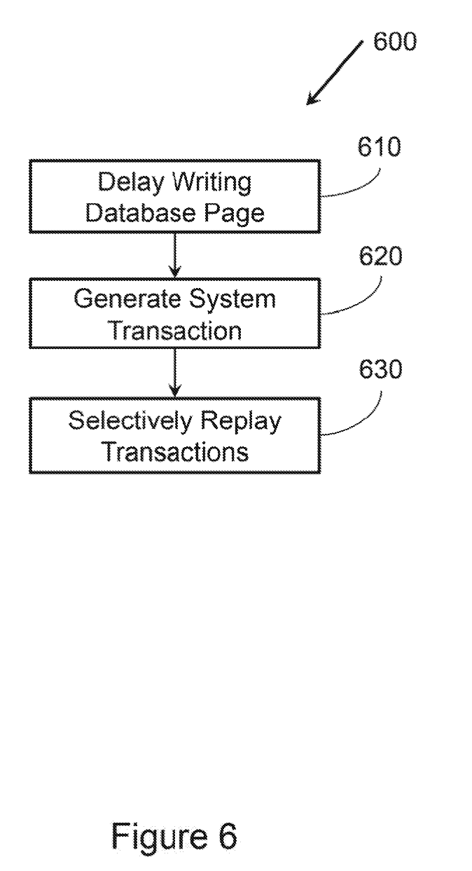

FIG. 6 illustrates a method 600 associated with database transaction replay. Method 600 includes delaying writing a database page to a persistent portion of a database at 610. The writing may be delayed until transactions associated with the database page remain uncommitted.

Method 600 also includes generating a system transaction at 620. The system transaction may be generated in response to detecting a user transaction that would cause a modification of a structure of a database entry. The system transaction may perform the modification of the structure of the database entry.

Method 600 also includes selectively replaying transactions during a system recovery after a system failure at 630. The actions replayed during the system recovery may be those identified in a recovery log that committed prior to the system failure.

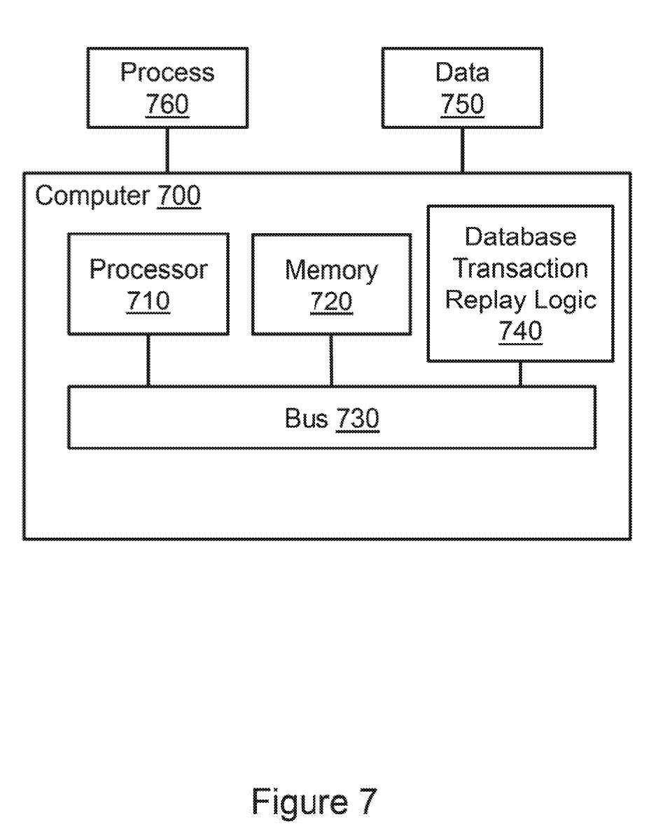

FIG. 7 illustrates an example computing environment in which example systems and methods, and equivalents, may operate. The example computing device may be a computer 700 that includes a processor 710 and a memory 720 connected by a bus 730. The computer 700 includes a database transaction replay logic 740. In different examples, log archive sorting logic 740 may be implemented as a non-transitory computer-readable medium storing computer-executable instructions in hardware, software, firmware, an application specific integrated circuit, and/or combinations thereof.

The instructions may also be presented to computer 700 as data 750 and/or process 760 that are temporarily stored in memory 720 and then executed by processor 710. The processor 710 may be a variety of various processors including dual microprocessor and other multi-processor architectures. Memory 720 may include volatile memory (e.g., read only memory) and/or non-volatile memory e.g., random access memory). Memory 720 may also be, for example, a magnetic disk drive, a solid state disk drive, a floppy disk drive, a tape drive, a flash memory card, an optical disk, and so on. Thus, memory 720 may store process 760 and/or data 750. Computer 700 may also be associated with other devices including other computers, peripherals, and so forth in numerous configurations (not shown).

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. A non-transitory computer-readable medium storing computer-executable instructions that when executed by a computer cause the computer to:
prevent a database page from being written to a persistent portion of a database while there are uncommitted transactions associated with the database page; and
in response t detecting a system failure associated with the database:
analyze the database to identify a set of transactions that were committed and unwritten to the persistent portion when the system failure occurred; and
re-perform members of the set of transactions.

2. The non-transitory computer-readable medium of claim 1, where the database page is prevented from being written to the persistent portion of the database by holding the database page in a buffer pool.

3. The non-transitory computer-readable medium of claim 1, where the database page is prevented from being written to the persistent portion of the database by storing the database page in a portion of the database separate from the persistent portion of the database.

4. The non-transitory computer-readable medium of claim 3, where the instructions further cause the computer to:
overwrite a value, after the uncommitted transactions have been committed, in the database to indicate that the database page should be treated as part of the persistent portion of the database.

5. The non-transitory computer-readable medium of claim 3, where the database is structured as a partitioned b-tree and where the portion of the database separate from the persistent portion of the database is a partition of the partitioned b-tree.

6. The non-transitory computer-readable medium of claim 1, where analyzing the database to identify the set of transactions comprises analyzing a recovery log associated with the database, and where analyzing the database comprises appending a compensation log record to the recovery log identifying an action associated with an uncommitted transaction to signify that the action should not be reflected in the database.

7. The non-transitory computer-readable medium of claim 1, where the instructions further cause the computer to:
in response to detecting a triggering action of a user transaction that would cause a modification of a structure of a database entry:
generate a system level transaction to perform the modification of the structure of the database entry;
commit the system level transaction to a recovery log; and
perform the triggering action on the database entry.

8. The nor-transitory computer readable medium of claim 7, where performing the modification of the structure of the database entry creates a ghost database entry and where the instructions further cause the computer to: reclaim memory associated with the use of the ghost database entry.

9. The non-transitory computer-readable medium of claim 7, where the triggering action is an action that would cause one or more of creation of the database entry, deletion of the database entry, and resizing of the database entry.

10. A system, comprising:
a data store to store a set of pages of data associated with a database;
an isolation logic to hold a database page separate from a persistent portion of the data store while transactions associated with the database page remain uncommitted;
a transaction separation logic to detect when a triggering action of a user level transaction would cause a modification to a structure of a member of the set of pages and to generate a system level transaction to separate the modification of the structure and the triggering action; and
a system restoration logic to selectively cause a transaction to be re-performed during a restoration of the database upon determining the transaction was committed prior to beginning the restoration of the database.

11. The system of claim 10, where the system restoration logic scans a recovery log to identify transactions that committed prior to beginning restoration of the database.

12. The system of claim 11, where the system restoration logic appends a compensation log record to the recovery log identifying an action associated with an uncommitted transaction to signify that the action should not be reflected in the database.

13. The system of claim 10, where the isolation logic holds the database page separate from the persistent portion of the database by preserving the database page in one or more of, a buffer pool and a portion of the database separate from the persistent portion of the database.

14. The system of claim 10, where the system level transaction modifies the structure of the member of the set of pages by generating a ghost page to be held separate from the database at least until the user level transaction commits.

15. A method comprising:
delaying writing a database page to a persistent portion of a database while transactions associated with the database page remain uncommitted;
generating, in response to detecting a user transaction that would cause a modification of a structure of a database entry, a system transaction to perform the modification of the structure of a database entry;
selectively replaying, during a system recovery after a system failure, transactions that committed prior to the system failure by identifying the transactions that committed in a recovery log prior to the system failure.
